(19) United States
(12) Patent Application Publication
(10) Pub. No.: US 2021/0162485 A1
(43) Pub. Date: Jun. 3, 2021

(54) Component for a Machine Tool, Machine Tool, and Method for Identifying Wear

(71) Applicant: Bystronic Laser AG, Niederonz (CH)

(72) Inventor: Lars WOIDASKY, Gotha (DE)

(21) Appl. No.: 17/045,209

(22) PCT Filed: Apr. 4, 2019
(86) PCT No.: PCT/EP2019/000111

§ 371 Date: Nov. 30, 2020

(30) Foreign Application Priority Data
Apr. 5, 2018 (DE) 102018107998.2

(51) Int. Cl. B21D 55/00; B21D 5/02

(52) U.S. Cl. CPC B21D 55/00; B21D 5/02

(57) ABSTRACT

The present disclosure relates to a component for a machine tool, having a component main body and having at least two layers arranged thereon for identifying wear, wherein the layers for identifying wear are applied to a wear region of a component of the machine tool and wherein at least one of the two layers is a signaling layer for indicating the wear.

### CROSS REFERENCE TO RELATED APPLICATIONS

This application is a national phase application of International Application No. PCT/EP2019/000111, filed on Apr. 4, 2019, and claims the priority benefit of German Application 102018107998.2, filed on Apr. 5, 2018, the content of both of which is incorporated by reference.

### BACKGROUND OF THE INVENTION

The present disclosure relates to a bending tool for a bending machine, a machine table for a bending machine, a stop element for a bending machine, a bending machine and a method for identifying wear. In particular, the invention relates to a bending tool for a bending machine according to claim 1, a machine table for a bending machine according to claim 8, a stop element for a bending machine according to claim 9, a bending machine according to claim 10 and a method for identifying wear according to claim 14.

A machine tool is used to manufacture and machine workpieces using bending tools. For example, sheet metal working machines, in particular bending machines or presses such as press brakes are considered to be machine tools here. For the sake of clarity, reference is made below to press brakes.

Precisely set machine axes and dimensionally stable machine geometries are necessary for the production of high-quality and exact bent parts on press brakes. Continuous operation inevitably leads to machine wear and tear of particularly stressed components of bending machines. During regular operation, these components are worn away by constant contact with the workpiece or the tools by hitting, squeezing, sliding, etc. and thus lose their original shape. Ultimately, the shape and position deviations of the affected machine axes increase, and the quality of the bent parts produced decreases. In addition, the value of the machine is reduced.

Changes to reference surfaces can occur gradually and sometimes unnoticed if the bending results develop negatively within the defined tolerance range: the workpieces are still correct but become increasingly poor.

This fact is dealt with in part by calibrating and recalibrating moving machine axes—if this is possible. Recalibration requires constant quality control of the bending machine and trained specialist staff. Outside of this type of preventive maintenance, calibration is usually only carried out after defective batches of bent parts. As a result, the machine shuts down unexpectedly and cannot produce.

Wear-related, asymmetrical changes in shape of bending tools, machine tables and stop fingers cannot be corrected by readjusting—such components must be replaced. In this case, too, rejects are often produced before the fault is registered and the bending machine comes to an unscheduled standstill. The delivery times for the replacement parts often aggravate the situation even further.

DE 195 38 144 A1 discloses wearing components, preferably in systems and/or machines for scrap, bulky refuse or waste processing, in particular wear plates or wear sheets, such as in scrap shears or, in a broader sense, linings of machine beds exposed to wear.

US 2015/314359 A1 discloses a punching tool with a guide element. The guide element has at least one wear indicator cavity which is recessed into the guide surface.

US 2005/158511 A1 discloses a system for monitoring component wear for components such as brake linings, gears, sliding pieces and sliding fits or gas turbines. In the system, a conductor is embedded in a first component at a predetermined depth below the surface, wherein the conductor is exposed when worn to complete a circuit.

EP 1 057 586 A2 discloses a tool for uniform, punching or injection molding technology which is provided with a functional surface. The tool contains a module with a main body that can be integrated into the tool in a non-positive and form-fitting manner, wherein the main body has a module surface which, when installed, is embedded in and adapted to the functional surface of the tool and has an aerial arrangement of several thin-film sensors in the plane of the surface of the module.

### SUMMARY OF THE INVENTION

An object of the present disclosure is to avoid the disadvantages of the prior art and to provide an improved bending tool for a bending machine, an improved machine table for a bending machine, an improved stop element for a bending machine, an improved bending machine and an improved method for identifying wear.

This object is achieved by a bending tool for a bending machine according to claim 1, a machine table for a bending machine according to claim 8, a stop element for a bending machine according to claim 9, a bending machine according to claim 10 and a method for identifying wear according to claim 14.

The bending tool for a bending machine according to the invention comprises a main body and at least two layers arranged thereon for identifying wear, wherein the layers for identifying wear are applied to a wear region of a bending tool of the bending machine and wherein at least one of the two layers is a signaling layer for indicating the wear and wherein the consumable layer in the initial state is arranged relatively outside with respect to the base body and each signaling layer is arranged relatively between the consumable layer and the main body and/or a pair of layers made up of a further consumable layer and a signaling layer, wherein the signaling layer and the consumable layer completely cover the bending tool. The identification can be carried out optically, for example by color design, electrically, for example by cutting through an electrically conductive or non-conductive layer, or also acoustically, for example by means of a rough layer, and by combinations of the variants mentioned. The wear identification can be finely graded via the thickness, number and/or nature of the layers.

The bending tool for a bending machine according to the invention has the advantage that predictive maintenance and a consistently high processing quality, such as bending quality, are made possible. Such a layer structure offers great flexibility. Ultimately, all parts subject to wear can be equipped with the layers for identifying wear.

It can be provided that the at least two layers are arranged alternately as a consumable layer and as a signaling layer. In this case, the consumable layer can function as a functional layer and the signaling layer can function as a wear indicator. It is also possible that all layers are signaling layers, which then characterize different wear conditions. The at least two layers are layers that differ, for example, in terms of their composition from that of the bending tool or its main body.

The layers can, for example, be applied in one or more additional work steps after completion of the bending tool.

It can be provided that the signaling layer has a material with a low coefficient of friction. This mostly internal signaling layer can thus also have wear-minimizing properties or sliding properties.

It can further be provided that the signaling layer is color-coded and differs in color from the consumable layer(s) and/or the main body. After the outer layer or the consumable layer has been removed, the signaling layer, i.e., the layer underneath, becomes visible and clearly shown to the operator by the signal color. This gives the operating personnel a clear indication that the wear limit has been reached, the quality of the products to be manufactured is declining and the replacement of the component is imminent. Various signaling layers with correspondingly assigned colors can be used to provide a quantitative statement of the degree of wear. The degree of wear can thus be displayed to the user and further steps can be initiated. One possible color variant would be, for example, the use of the traffic light colors green, yellow, red. The currently translucent color can be transmitted manually or automatically to the machine control in order to adjust the infeed of the machine axes according to the degree of wear. With this optical variant, the user can identify the wear and tear directly, i.e., without a control.

It can be provided that one of the two layers (wear layer and signaling layer) has electrically conductive material and that the other of the two layers has electrically insulating material for insulating the electrically conductive material. Tools, machine tables and/or stop fingers are usually made of functionally optimized types of steel and are electrically conductive. An advantageous increase in the service life of these components can be achieved by applying various coatings that may influence, but generally do not prevent, the conductivity of the components. A component coating with an insulating and optionally also wear-minimizing coating enables the creation of a circuit with this insulating layer as a “switch”. The presence of the layer then fulfils the requirements for an intact reference surface and an open circuit. Damage to the insulation leads to a change in shape of the affected component and, at the same time, to a closed circuit. This change can be established and used for appropriate reactions. It goes without saying that the electrically conductive layer is surrounded by electrically insulating material on both sides of the layer (i.e., inwardly and outwardly), with the exception of possible contact points for closing the circuit or for forwarding electrical signals.

It can also be provided that a transponder is provided which is designed to output a signal if one of the two layers is damaged. The determined signs of wear can thus be clearly assigned to a replaceable component. Such components on press brakes, for example, are mainly bending tools, i.e., punches and dies. These bending tools can be freely combined with one another and are product specific. A constant change of these components is typical. It is therefore advantageous to be able to differentiate between these components. The outer layer can also function as a signaling layer, the damage of which is signaled by the transponder.

A machine tool according to the invention is designed for machining workpieces using tools and comprises at least one component as described above. The same advantages and modifications apply as described above.

It can be provided that a circuit is applied to the component, wherein the electrically conductive material of the at least one-layer functions as a switch. A voltage measurement can take place in the circuit, for example via a consumer. The resistance and thus the voltage can change as the current-carrying layer wears. In the event of further wear or severance, the circuit can be opened, which can also be detected.

It can furthermore be provided that a control is provided which is connected to the circuit, and that the control is designed to incorporate the wear determined on the basis of the circuit in the control of the machine tool. For example, corrections to the control of the machine axes and/or the feed can be made automatically.

It can be provided that a plurality of layers is provided and that each of the electrically conductive layers is connected to a circuit by means of electrically conductive material. In this way, further service life predictions are possible, for example with an automatic and periodic insulation measurement or the described application of several layers on the components subject to wear. For this purpose, alternating insulating and electrically conductive hard material layers are applied to the components. The progressive wear and tear of the components opens or closes the applied electrical circuit. A metering of this process can determine the layer or component thickness. In this way, statements can be made on the remaining service life, for example. The accuracy is directly dependent on the thickness and number of layers.

A method according to the invention for identifying wear on a component of a machine tool as described above comprises the steps of:

checking the circuit with the electrically conductive material of the layer for interruption;

detecting an interruption; and

if an interruption is detected, storing the interruption and/or adapting the control of the machine tool as a function of the wear determined on the basis of the interruption in the circuit.

The resulting knowledge of the geometric changes in the machine components can lead to automatic calibrations and keep the bending quality constant. For example, a symmetrically worn stop finger can be repositioned by the back stop and used again. Progressively worn tools can be classified using suitable means (e.g., data matrix codes, etc.) and assigned accordingly: Similar worn tools are recognized by the machine and used together for a product—the machine axis (in this case the upper beam) can correct the relative value and produce a constant bending angle. Otherwise, the same advantages and modifications apply as described above.

It can be provided that an interruption is detected continuously, wherein an electrically conductive workpiece closes the circuit. The layer thicknesses can then be determined continuously throughout the entire machining process.

It can be provided that an interruption is detected by bringing the component into contact with an electrically conductive part of the machine tool in order to close the circuit. An initialization phase requires a recurring connection with a conductive, stationary material on the machine. The component to be checked for wear is then positioned with the machine axis at a specified point within the machine. This intermediate element can, for example, be an electrically conductive brush. The avoidance of an undesired collision (contact region) and the covering of a large inspection region (no line contact) are advantageous here.

It can furthermore be provided that, when a wear is determined which indicates the end of the maximum possible usage time of the component, an automated spare parts order is triggered. For example, an automated spare parts order can be triggered by the machine control so that the replacement component is advantageously already available when the end of the maximum usage time of the component is reached.

Further preferred embodiments of the invention will become apparent from the remaining features mentioned in the dependent claims.

The various embodiments of the invention mentioned in this application can, unless otherwise stated in individual cases, be advantageously combined with one another.

### BRIEF DESCRIPTION OF THE SEVERAL VIEWS OF THE DRAWINGS

The invention will be explained below in exemplary embodiments with reference to the accompanying drawings. In the figures:

FIG. 1 shows a schematic front view and top view of a component with optical wear identification;

FIG. 2 shows a schematic front view and top view of a worn component with optical wear identification;

FIG. 3 shows a perspective view of a bending machine with a component with wear identification as a stop finger;

FIG. 4 shows a schematic representation of a component with electrical wear identification;

FIG. 5 shows a perspective view of a bending machine with a punch and die;

FIG. 6 shows a schematic representation of a die with electrical wear identification; and

FIG. 7 shows a schematic representation of the punch with electrical wear identification.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

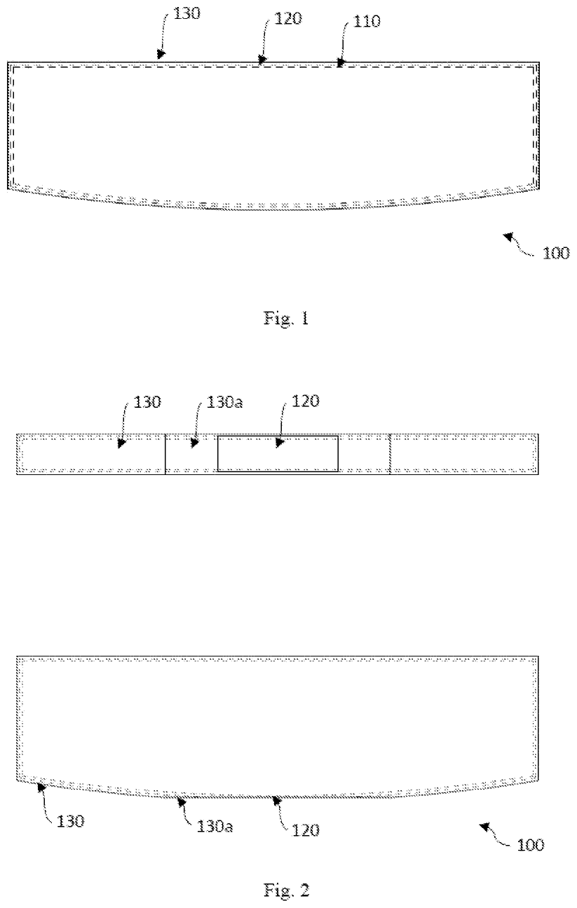

FIG. 1 shows a schematic front view and top view of a component 100 with a component core or component main body 110 and optical wear identification 120, 130 applied thereon. The component 100 can be a wear part of a bending machine, in particular a tool, a machine table and/or a stop element such as a stop finger. Correspondingly, the wear part of a bending machine can comprise a main body 110 with optical wear identification 120, 130 attached thereon.

The component 100 is provided with an outer hard material layer or consumable layer 130 according to the intended use. Possible materials here are, for example, PVD and/or CVD hard material layers or materials such as titanium nitride. The layer thickness is selected with regard to the application and the expected component wear. The layer thickness is advantageously 1 to 10 micrometers and particularly advantageously 1 to 20 micrometers. In addition, greater layer thicknesses can also be used. The layer thickness depends on the application method and the subsequent adhesion to the component 100 or the layer below.

It does not matter whether the layer has conductive or insulating properties. A further layer, a signaling layer 120, was applied below the outer consumable layer 130 during component manufacture. This signaling layer 120 is clearly distinguishable in color from the consumable layer 130 and is advantageously applied in a signal color.

Various colors are possible, such as gold, blue-grey, red-brown, grey, pearl pink, pink, etc. It is particularly important to distinguish between the layers. The color results from the applied material, e.g., TiN is golden yellow, and/or from variations in the application technology. The entire layer accordingly consists of a colored material, i.e., as long as parts of the layer are still present, the color can still be clearly recognized.

This inner signaling layer 120, like the consumable layer 130, can have wear-minimizing properties. For example, titanium nitride is a common all-round wear coating. Layers made of titanium carbonitride or titanium chromium nitride are also conceivable. The signaling layer 120 is applied to a component main body 110 of the component 100. The signaling layer 120 and also the consumable layer 130 can be applied specifically in a wear region of the component 100, such as a surface, edge, three-dimensional region, etc. Likewise, the layers 120 and 130 can completely cover the component 100 as shown.

FIG. 2 shows a schematic front view and top view of a worn component 100 with optical wear identification.

When the component 100 is used, the outer consumable layer 130 is continuously removed by contact with the workpiece. This creates a region 130a in which the outer consumable layer 130 is partially removed, i.e., worn. As already described, the geometry of the component 100 changes, the component 100 wears. After the outer consumable layer 130 has been completely removed, the inner, i.e., the underlying signaling layer 120 is visible (which differs both from the color of the consumable layer 130 and from the intrinsic color of the component main body 110) and is clearly displayed to the operator by the signal color. This gives the operating personnel a clear indication that the wear limit has been reached, the quality of the products is declining, and the replacement of the component is imminent.

In the optimal case, after the consumable layer 130 has been completely removed, i.e., the signaling layer 120 underneath has been exposed, there is enough time to replace the parts before the component 100 fails. The remaining time can be defined via the thickness of the outer consumable layer 130. Various layers with correspondingly assigned colors can be used to provide a quantitative statement of the degree of wear. The degree of wear can thus be displayed to the user and further steps can be initiated. One possible color variant would be, for example, the use of the traffic light colors green, yellow, red. The currently translucent color can be transmitted to the machine control in order to adjust the infeed of the machine axes according to the degree of wear. In this example, the consumable layer 130 could have the color green, the signaling layer 120 would have the color yellow and the component main body 110 would have the color red. Alternatively, only the signaling layer 120 might have a color, for example red.

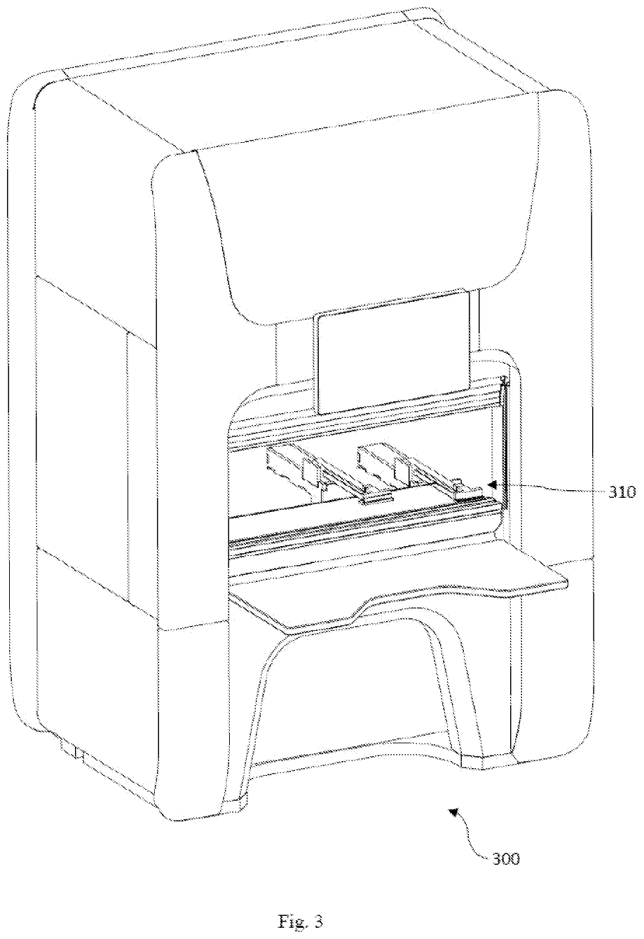

FIG. 3 shows a perspective view of a bending machine 300 with a component with wear identification as a stop finger 310. Stop fingers 310 of bending machines 300 enable correct leg lengths of the bent parts by striking and positioning the sheet metal relative to the bending line. The finger contours optimized for this are subject to high wear due to sheet positioning and pivoting during the bending process. As a result, the bent parts can then no longer be correctly positioned. Methods of heat treatment of the stop fingers 310 are already known to minimize wear. Subsequently, the components are coated with physical and/or chemical vapor deposition, for example.

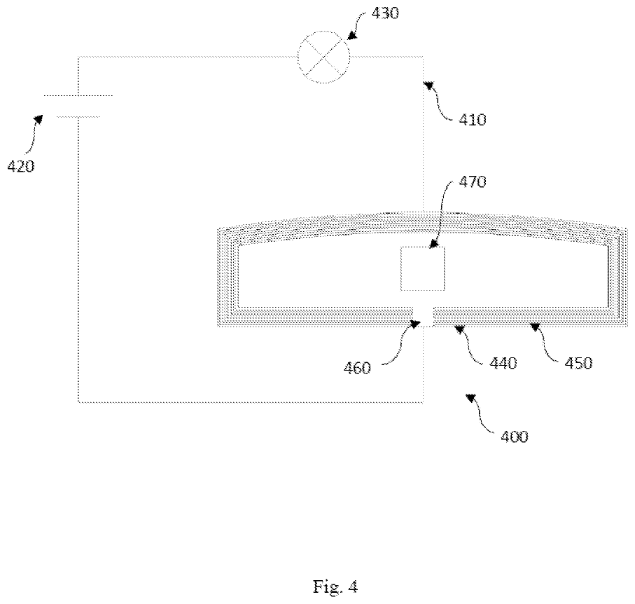

FIG. 4 shows a schematic representation of a component 400, for example a stop finger, with electrical wear identification. For this purpose, the component 400 is connected to an electrical circuit 410 or is part of the electrical circuit 410. The electrical circuit 410 comprises a supplier such as a voltage source and a consumer 430 at which electrical parameters such as voltage or current can be measured. The component 400 then functions as a switch. In other words, the component 400 is sometimes a conductor and sometimes an insulator. A suitable consumer 430 monitors and displays whether the circuit 410 is closed.

The component 400 is provided with a plurality of alternating insulating layers 440 and electrically conductive layers 450 during manufacture. The electrically conductive layers 450 have electrically conductive material or consist entirely of this material. These layers 440, 450 are configured to be application-related and, in addition to minimizing wear, can also be provided with sliding properties. Most DLC coatings (diamond-like carbon) achieve good sliding properties, but PVD coatings (physical vapor deposition) are also advantageous compared to untreated or only heat-treated materials. The layer thickness is precisely determined by the manufacturing process of the component 400. At least one electrically conductive layer and one insulating layer must be present. The order the layers 440, 450 are applied is irrelevant here. The thicknesses of the applied layers 440, 450 can vary, a thickness in the absolute value of the tolerated wear is advantageous. The respective thicknesses must be known and stored in a control, for example in the machine control. With the exception of a connection point 460, the finger is insulated on all sides and is therefore no longer electrically conductive.

When installed, an electrical voltage is applied to the machine, for example with the anode on the conductive point of the finger and the cathode on the machine table or the die. The positioning of bent parts—predominantly made of conductive materials—in the bending process does not lead to a closed circuit, as the insulating hard material layer of the finger is still completely intact. Increasing wear on the finger removes the insulating layer 440 until the circuit 410 is closed. Using suitable evaluation mechanisms—normally the machine control—the contact is established and measures are taken. Ideally, the tolerated deviation has now been reached and the finger would have to be swapped.

A wearing component 400 will alternately open and close the circuit 410. The number of these processes and the layer thickness value allow an exact conclusion about the degree of wear of the component 400 and are stored and further processed in the machine control. The constantly changing geometry of the component 400 can be included in the production process and the affected machine axis can be adjusted in advance. The affected machine axis is then always readjusted by the amount of the worn layer.

The checking of the components 400 can take place continuously in the bending process or as initialization. During the bending process, the electrically conductive workpiece 400 is used as a component of the circuit 410 and is included in the test. The layer thicknesses can then be determined in the entire bending process.

An initialization phase requires a recurring connection with a conductive, stationary material on the machine. The component 400 to be checked for wear is then positioned with the machine axis at a specified point within the machine. According to the invention, this intermediate element is an electrically conductive brush. The avoidance of an undesired collision (contact region) and the covering of a large inspection region (no line contact) are advantageous here. A line contact or sometimes a point contact may be desired. Although the brush enables a 3D contour to be scanned, this can complicate the detection as the component is worn. To simplify this process, it can be advantageous to monitor a point or a line—either exclusively or in addition.

The principle of identifying wear through conductivity is in principle not limited to electrical conductivity. Alternatively, conductivity for electromagnetic waves, for example light, or magnetic flux could also be used. Such embodiments are also considered to be according to the invention.

An exemplary sequence is shown below.

During an initial test of the component 400, the circuit 410 is closed. If the outer insulating layer 440 is still intact, there is no signal at the consumer 430. There is no message to the machine control.

After working with the component, i.e., contact with the workpiece, the component 400 is tested, and the circuit 410 is closed. If the outer insulating layer 440 is still intact, there is no signal at the consumer 430. There is no message to the machine control.

After working further with the component, i.e., contact with the workpiece, the component 400 is tested, and the circuit 410 is closed. The outer insulating layer 440 is now no longer intact, the conductive layer 450 is on the outside, and there is a signal at the consumer 430. A message is therefore sent to the machine control. The new component geometry is offset in the form of a subtraction of the amount of the outermost layer 440 and a recalibration of the relevant machine axis or machine axes.

After working further with the component, i.e., contact with the workpiece, the component 400 is tested, and the circuit 410 is closed. The conductive layer 450 is still intact, there is a signal to the consumer 430. There is no message to the machine control.

After working further with the component, i.e., contact with the workpiece, the component 400 is tested, and the circuit 410 is closed. The conductive layer 450 is now no longer intact, the next insulating layer is on the outside, and consequently there is no signal at the consumer 430. A message is therefore sent to the machine control. The new component geometry is offset in the form of a subtraction of the amount of the conductive layer 450 and a recalibration of the relevant machine axis or machine axes.

This procedure is continued until the last layer is reached or until the component 400 is replaced as part of maintenance.

The absolute frequency of the measurements depends on various factors and is variable. The conductive layers 450 can each be checked with their own circuit, then a more precise localization of the interruption (damaged region) and thus a more differentiated statement of wear is possible. A further improvement is created by a two- or three-dimensional layer structure. Complex geometries can thus be monitored.

The component 400 is also equipped with a transponder 470, which is designed to output a signal if one of the two layers 440, 450 is damaged.

The determined signs of wear can now be clearly assigned to a replaceable component 400. Such components on press bakes are mainly bending tools, i.e., punches and dies. Bending tools can be freely combined with one another and are product specific. A constant change of these components is typical. It is therefore necessary to differentiate between these components.

A clear assignment of the degree of wear can advantageously be achieved with an RFID system. The RFID transponder 470 is attached to the tool 400 and identifies the same. The transponder 470 is coupled to the layer structure described and sends a signal whenever a layer has been damaged. The machine control can also correct the feed rate in accordance with the changed geometry. Suggestions for an advantageous division of the components are also conceivable: Evenly worn components are preferably grouped together. The tools can also be clearly assigned using a code (QR code, barcode, 2D code, numeric input, etc.). The code is read out appropriately and the data is transferred to the machine control system or entered by the operator.

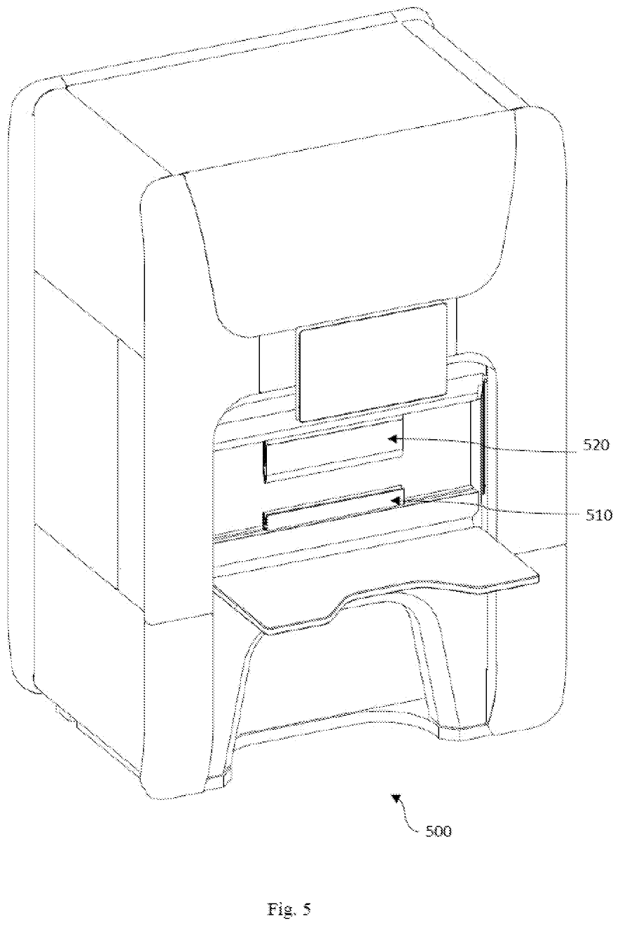

FIG. 5 shows a perspective view of a machine tool in the form of a bending machine 500 having die 510 and punch 520. The two components in the form of the die 510 and the punch 520 are provided with wear identification or wear monitoring as described above.

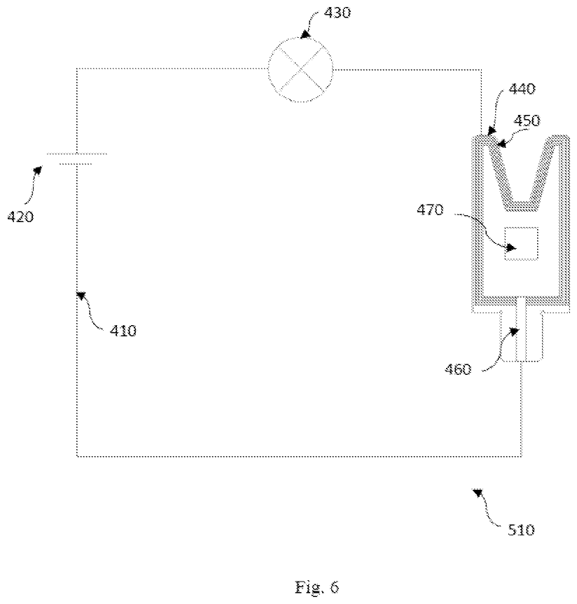

FIG. 6 shows a schematic representation of the die 510 with electrical wear identification. The die 510 is connected to an electrical circuit 410 or is part of the electrical circuit 410. The electrical circuit 400 comprises a supplier such as a voltage source and a consumer 430 at which electrical parameters such as voltage or current can be measured. The die 510 then functions as a switch. In other words, the die 510 is sometimes a conductor and sometimes an insulator. A suitable consumer 430 monitors and displays whether the circuit 410 is closed.

The die 510 is provided with a plurality of alternating insulating layers 440 and conductive layers 450 during manufacture. The conductive layers 450 have electrically conductive material or consist entirely of this material. These layers 440, 450 are configured to be application-related and, in addition to minimizing wear, can also be provided with sliding properties. The layer thickness is precisely determined by the manufacturing process of the die 510. At least one conductive layer and one insulating layer must be present. The order in which the layers 440, 450 are applied is irrelevant here. The thicknesses of the applied layers 440, 450 can vary, a thickness in the absolute value of the tolerated wear is advantageous. With the exception of a connection point 460, the die 510 is insulated on all sides and is therefore no longer electrically conductive. A transponder 470 for identifying the die 510 and for reporting the state of wear or a layer change is provided on the die 510.

When the machine tool is in operation, the die 510 can be used analogously to the description above.

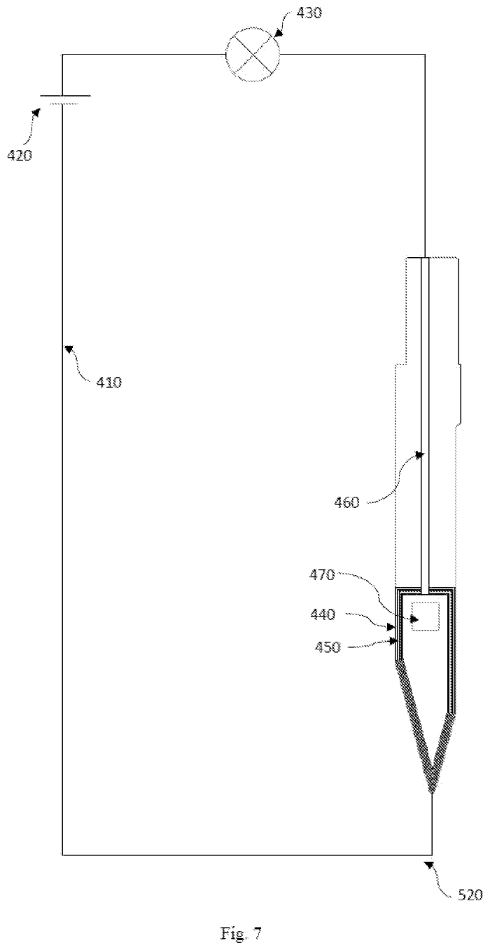

FIG. 7 shows a schematic representation of the punch 520 with electrical wear identification. The punch 520 is connected to an electrical circuit 410 or is part of the electrical circuit 410. The electrical circuit 400 comprises a supplier such as a voltage source and a consumer 430 at which electrical parameters such as voltage or current can be measured. The punch 520 then functions as a switch. In other words, the punch 520 is sometimes a conductor and sometimes an insulator. A suitable consumer 430 monitors and displays whether the circuit 410 is closed.

The punch 520 is provided with a plurality of alternating insulating layers 440 and conductive layers 450 during manufacture. The conductive layers 450 have electrically conductive material or consist entirely of this material. These layers 440, 450 are configured to be application-related and, in addition to minimizing wear, can also be provided with sliding properties. The layer thickness is precisely determined by the manufacturing process of the punch 520. At least one conductive layer and one insulating layer must be present. The order in which the layers 440, 450 are applied is irrelevant here. The thicknesses of the applied layers 440, 450 can vary, a thickness in the absolute value of the tolerated wear is advantageous. With the exception of a connection point 460, the punch 520 is insulated on all sides and is therefore no longer electrically conductive. A transponder 470 for identifying the punch 520 and for reporting the state of wear or a layer change is provided on the punch 520.

When the machine tool is in operation, the punch 520 can be used analogously to the description above.

The die 510 and the punch 520 are each shown with a separate circuit 410. Another possibility is to use a common circuit which is then closed by an electrically conductive workpiece located between the die 510 and the punch 520.

The wear identification presented here allows simple and precise detection of the respective wear state of one or more components of a machine tool, so that the machine control can be adapted, and corresponding maintenance processes can be initiated.

In addition, the machine control system can trigger an automated order for spare parts if wear is determined that indicates the end of the maximum possible usage time of the component. As a result, the replacement component can already be available when the end of the maximum usage time of the component is reached.

1. A component (100, 400) for a machine tool, having a component main body (110) and having at least two layers (120, 130; 440, 450) arranged thereon for identifying wear, wherein the layers (120, 130; 440, 450) for identifying wear are applied to a wear region of a component (100, 400) of the machine tool and wherein at least one of the two layers (120, 130; 440, 450) is a signalling layer (120) for indicating the wear.

2. The component (100, 400) for a machine tool according to claim 1, characterised in that the at least two layers (120, 130; 440, 450) are arranged alternately as a consumable layer (130) and as a signalling layer (120).

3. The component (100, 400) for a machine tool according to claim 1, characterised in that each consumable layer (130) in the initial state is arranged relatively outside with respect to the component main body (110) and each signalling layer (120) is arranged relatively between the consumable layer (130) and the component main body (110) and/or a further pair of layers made up of a consumable layer (130) and a signalling layer (120).

4. The component (100, 400) for a machine tool according to any one of the preceding claims, characterised in that the component (100, 400) is a tool (400), a machine table and/or a stop element.

5. The component (100, 400) for a machine tool according to any one of the preceding claims, characterised in that the component (100, 400) is a wear part of a bending machine, in particular a tool (400), a machine table and/or a stop element.

6. The component (100, 400) for a machine tool according to any one of the preceding claims, characterised in that the signalling layer (120) has a material with a low coefficient of friction.

7. The component (100, 400) for a machine tool according to any one of the preceding claims, characterised in that the signalling layer (120) is colour-coded and differs in colour from the consumable layer(s) (130) and/or the component main body (110).

8. The component (100, 400) for a machine tool according to any one of the preceding claims, characterised in that one of the two layers (450) has electrically conductive material and in that the other of the two layers (440) has electrically insulating material for insulating the electrically conductive material.

9. The component (100, 400) for a machine tool according to claim 8, characterised in that a transponder (470) is provided which is designed to output a signal if one of the two layers (120, 130; 440, 450) is damaged.

10. A machine tool designed for machining workpieces (400) using tools (400) having at least one component (100, 400) according to any one of claims 1 to 9.

11. The machine tool according to claim 10 having at least one component (100, 400) according to any one of claim 8 or 9, characterised in that a circuit (410) is set up on the component (100, 400), wherein the electrically conductive material functions as a switch.

12. The machine tool according to claim 11, characterised in that a control Is provided which is connected to the circuit (410), and in that the control is designed to incorporate the wear determined on the basis of the circuit (410) in the control of the machine tool.

13. The machine tool according to claim 11 or 12, characterised in that a plurality of layers (120, 130; 440, 450) are provided and in that each of the electrically conductive layers (450) is connected to a circuit (410) by means of electrically conductive material.

14. A method for identifying wear of a component (100, 400) of a machine tool according to any one of claims 10 to 12, having the steps of:
checking the circuit (410) with the electrically conductive material of the layer (450) for interruption;
detecting an interruption;
if an interruption is detected, storing the interruption and/or adapting the control of the machine tool as a function of the wear determined on the basis of the interruption in the circuit (410).

15. The method according to claim 14, characterised in that an interruption is detected continuously, wherein an electrically conductive workpiece (400) closes the circuit (410).

16. The method for identifying wear according to claim 14, characterised in that an interruption is detected by bringing the component (100, 400) into contact with an electrically conductive part of the machine tool in order to close the circuit (410).

17. The method for identifying wear according to any one of claims 14 to 16, characterised in that, when a wear is determined which indicates the end of the maximum possible usage time of the component (100, 400), an automated spare parts order is triggered.
